(19) United States
(12) Patent Application Publication
(10) Pub. No.: US 2026/0321949 A1
(43) Pub. Date: Oct. 15, 2026

(54) COAXIALLY FED RIDGED WAVEGUIDE FEED WITH INNOVATIVE COAX-TO-WAVEGUIDE TRANSITION

(71) Applicant: NETQui j.s.a., Humenne (SK)

(72) Inventors: Martin Marcincák, Humenné (SK); Pavol Capek, Stupava (SK); Peter Svihura, Humenné (SK)

(73) Assignee: NETQui j.s.a., Humenne (SK)

(21) Appl. No.: 19/179,533

(22) Filed: Apr. 15, 2025

(51) Int. Cl. H01P 5/103; H01P 1/165; H01P 3/127

(52) U.S. Cl. CPC H01P 5/103

(57) ABSTRACT

A waveguide feed fed by a coaxial transmission line, includes at least one ridge within the feed, wherein the coaxial transmission line comprises semi-rigid or semi-flexible coaxial cable, the cable being routed inside the ridge, and electrically coupled to the ridge, generally without using a coaxial connector. This can be generally accomplished without forming deep, machined holes. The structures lend themselves to modular manufacturing techniques due to the use of components which may be standardized in shape and dimensions and shared with different designs or design variations, and thus reduce manufacturing costs. A method of assembling the waveguide feed and a coaxial transmission line.

### BACKGROUND OF THE DISCLOSURE

### 1. Field of the Disclosure

The present disclosure relates to transitions between coaxial transmission lines and waveguides. More particularly it relates to a structural solution enabling precise and efficient placement of coaxial transmission lines inside of coaxially fed ridged waveguides.

### 2. Description of Related Art

Common solutions for feeding waveguides through coaxial transmission lines require mechanical drilling of long holes into ridges to place the coaxial connector. The coaxial connector body remains on the outer part of the waveguide while only the center conductor enters the waveguide structure. Precise drilling for the center conductor pathways is required to ensure high precision for air in the gap to function as a dielectric. One end of the waveguide contains the connector, with its center conductor passing through a precisely drilled hole in the ridge to the opposite ridge, where a galvanic connection is established. This assembly method introduces significant challenges. The holes are very small in diameter, must be very precise and also very long. The drilling process requires high mechanical precision, as the performance of the coaxial transmission line inside the ridge is directly related to the quality of the drilled hole. Drilling of sub 2 mm diameter holes is a highly demanding, tool and time intensive process. In other methods, the dielectric and center conductor enter the waveguide structure. In some other methods, a special custom connector with an extended body is used. The importance of drilling of high precision long narrow holes in the ridge remains high with these methods.

Alternative methods to drilling, such as electrical discharge machining, are also used, as these are comparably less tool-intensive, but introducing an even slower rate of machining than drilling. Slow manufacturing processes, high demands on precision, cost of tools and time are important challenges of the prior art and methods in practical applications, such as high-volume manufacturing and/or rapid prototyping.

Thus, there is a need for a technique for a transition from a coaxial cable to a ridged waveguide that is simple, inexpensive, and does not require precise and elaborate drilling or other machining, or a costly custom connector.

### SUMMARY OF THE DISCLOSURE

In general, an embodiment of the disclosure is directed to connecting a semi-rigid or semi-flexible shielded coaxial cable, ensuring precise and stable signaling within the waveguide structure. Using shielded semi/rigid or semi/flexible cables provides excellent mechanical stability and consistent electrical parameters, eliminating the need for precise mechanical drilling, electric discharge machining, or other computer numerical control (CNC) processing. The use of a shielded coaxial cable allows for more precise positioning and easier manufacturing, particularly at ridge terminations, directly impacting manufacturing repeatability and optimizing VSWR, ensuring excellent signal transmission

The disclosure is also directed to structural splitting of ridges (ridge splitting) at the coaxial transmission transition point. The waveguide ridges can be designed with longitudinal or transverse segmentation, creating a guiding groove for the coaxial cable. This design facilitates simple CNC machining, where instead of complex and precise drilling of long, low diameter holes, longitudinal or transverse grooves can be machine-milled with sufficient accuracy, and in a much shorter time. The precise placement and routing are ensured by the coaxial transmission line itself rather than an internal connector

The disclosure is further directed to techniques for coaxial cable termination outside of the waveguide. In view of coaxial transmission inside the ridge, termination can be with a standard coaxial connector, or the cable can be left with an open end for direct connection to the end device, as required by the application.

In accordance with the disclosure, a waveguide feed fed by a coaxial transmission line, comprises at least one ridge within the feed, wherein the coaxial transmission line comprises semi-rigid or semi-flexible coaxial cable, the cable being routed inside the ridge, and electrically coupled to the ridge without using a coaxial connector. The ridge, at a transition between the coaxial transmission line and the ridge, is longitudinally or transversely split.

The coaxial signal transmission line can pass through multiple ridges and multiple coaxial transmission lines can cross within the waveguide structure, enabling multi-polarization configurations for optimized electromagnetic signal propagation. Thus, a second coaxial signal transmission line in a plane parallel to and spaced from a plane of a first coaxial transmission lines within the waveguide structure, so that a center conductor of the second coaxial signal transmission line and a center conductor of the first coaxial signal transmission line do not come into contact. The number of waveguide ridges is at least two, and in some embodiments may be four.

The waveguide feed can have a configuration that enables internal routing of the coaxial signal within the ridge, for example in an arbitrary direction. in a manner that alters transmission direction, whereby design flexibility is increased and integration into systems is facilitated. The coaxial transmission line can be routed within the ridge in a direction independent of a direction of a termination orientation of opposing ridges.

The waveguide feed can have a guiding groove optimized for precise placement of the coaxial transmission line, considering its diameter and routing requirements, to allow stable fixation of the coaxial transmission line and to minimize mechanical tolerances within the internal structure. The waveguide feed can have a circular or a rectangular cross section. The waveguide can be integrated as part of a coax-to-waveguide transition within an antenna.

The waveguide feed can be designed to be removable from a waveguide. This can be accomplished by, for example, using a quick release locking mechanism.

In accordance with the disclosure, a method of assembling a waveguide feed fed by a coaxial transmission line and the coaxial transmission line, comprises removing an outer insulator layer from an end portion of the coaxial transmission line to expose an outer conductor of the coaxial transmission line; removing the outer conductor and inner insulator layer from a center conductor of a portion of the end of the coaxial transmission line; placing the coaxial transmission line in a groove in at least one rib of the waveguide feed; and securing the end of the coaxial transmission line in the waveguide feed so that the outer conductor of the coaxial transmission line is in contact with a first rib of the waveguide feed and the center conductor is in contact with a second rib of the waveguide feed.

The coaxial transmission line can fit closely in the groove in the rib in the waveguide feed. The waveguide feed can be split into two portions. The two portions can be assembled to secure the coaxial transmission line within the waveguide feed. A portion of the groove can be in each of the two portions.

A ferule can be secured around the coaxial transmission line and received in an opening in the waveguide feed to secure the coaxial transmission line in the waveguide feed.

### BRIEF DESCRIPTION OF THE DRAWINGS

FIG. 1 is a perspective view, partially in transparent outline, of a first embodiment.

FIG. 2 is a perspective, exploded view of the embodiment of FIG. 1.

FIG. 3 is a perspective, exploded view of a second embodiment.

FIG. 3A is a perspective, partially transparent view of the assembled second embodiment of the invention as illustrated in FIG. 3.

FIG. 4 is a perspective view of the bottom portion of FIG. 1 or FIG. 2.

FIG. 4A is an enlarged view of portion A of FIG. 4.

FIG. 5 is a perspective, cross-sectional view, partly in transparent outline, of a third embodiment.

FIG. 6 is a perspective, cross-sectional view, partly in transparent outline, of a fourth embodiment.

FIG. 7 is similar to FIG. 7, illustrating an additional component.

FIG. 8 is a perspective, cross-sectional view of a sixth embodiment.

FIG. 9 is a perspective, cross-sectional view of a seventh embodiment.

FIG. 10 is a perspective view of an eight embodiment.

FIG. 11 is a partially transparent view of the embodiment of FIG. 10, showing internal components thereof

A component or a feature that is common to more than one drawing is indicated with the same reference number in each of the drawings.

### DESCRIPTION OF THE EMBODIMENTS

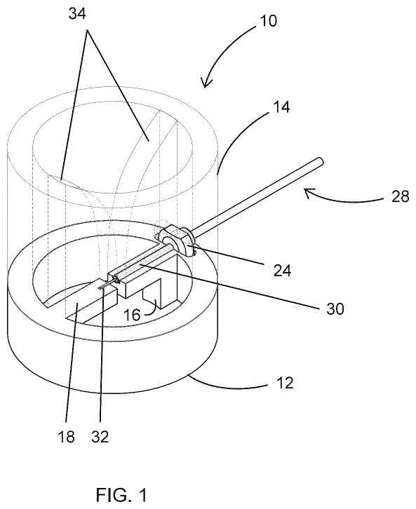

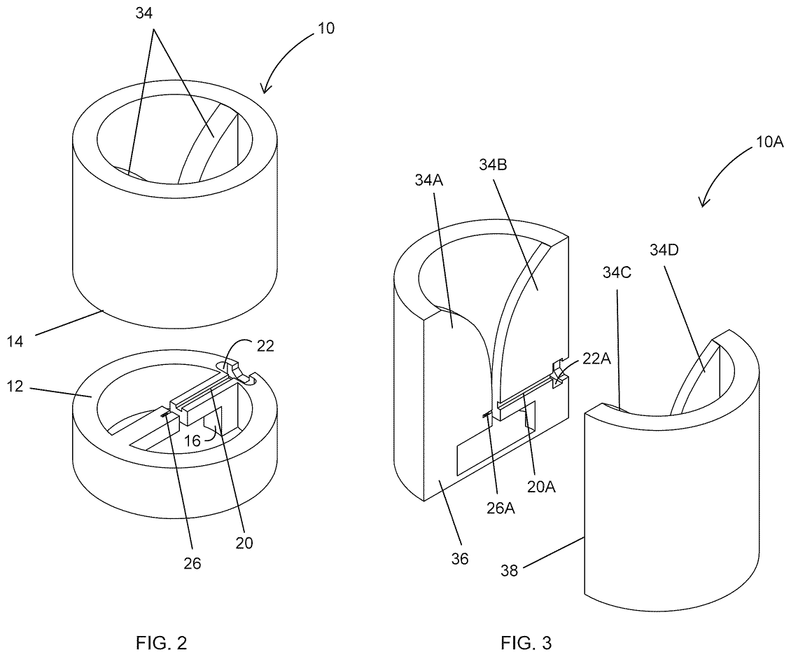

Referring to FIG. 1 and FIG. 2, waveguide feed 10 has a base portion 12 and a waveguide portion 14 which is designed to mate with base portion 12, and may be affixed thereto, with suitable coupling members such as screws or bolts (not shown). Base portion 12 has internal ledge members 16 and 18. Member 16 is electrically conductive and has a groove 20 which extends to a cavity 22 for receiving a ferrule 24. Member 18 has a short groove 26 formed on its surface.

A semi-rigid or semi-flexible coaxial conductor, such as a coaxial cable 28, which may be, for example, RG405 or RG402 coaxial cable, is prepared for connection to waveguide feed 10 by removing, along a portion of its length, its outer insulating cover to expose it outer conductive shield 30 so that a firm electrical contact can be made to member 16, when coaxial cable 28 is inserted through ferrule 24. At its end, outer conductive shield 30 and the inner insulator of coaxial cable 28 are removed to expose inner conductor 32 of coaxial cable 28. Inner conductor 32 is received in groove 26 of internal ledge members 18. When the prepared end of coaxial cable 28 has been positioned as shown in FIG. 1, ferrule 24 may be rotated to tighten upon and hold coaxial cable 28 firmly in place within base portion 12 of waveguide feed 10.

Upon installation of coaxial cable 28 within base portion 12 of waveguide feed 10, waveguide portion 14 of waveguide feed 10 can be assembled to base portion 12 as shown in FIG. 1, with the use of conventional assembly means, such as screws and bolts (not shown). The positioning of coaxial cable 28 within waveguide feed 10 allows for efficient radio frequency coupling between coaxial cable 28 and waveguide feed 10, with a low standing wave ratio (SWR). Specifically. radio frequency energy is efficiently coupled between coaxial cable 28 and ribs 34 within waveguide portion 14 of waveguide feed 10. Ribs 34 align with internal ledge members 16 and 18. This assists in holding coaxial cable 28 in place within waveguide feed 10.

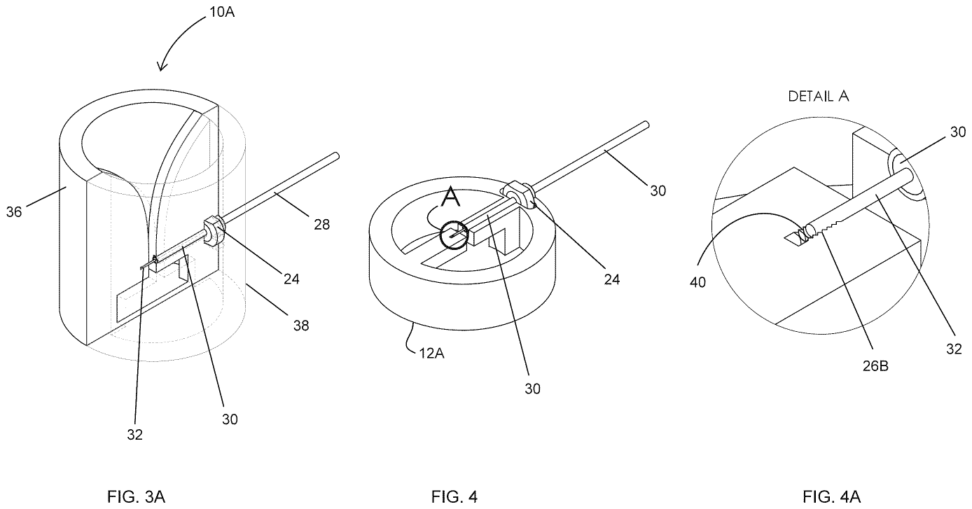

In the embodiment of FIG. 3 and FIG. 3A, a waveguide feed 10A is divided along its longitudinal axis into a first half 36 and a second half 38. First half 36 has ribs 34A and 34B. Rib 34A has formed therein a groove 20A and an opening 22A for receiving a ferrule (not shown in FIG. 3). Rib 34B has formed therein a groove 26A.

The groove 20A and the groove 26A are sized and shaped to receive a coaxial cable (not shown in FIG. 3) in the same way as the corresponding grooves of FIG. 1 and FIG. 2. The preparation of the coaxial cable and the use of a ferrule are as described above with respect to FIG. 1 and FIG. 2, to receive and hold the coaxial cable in place.

Second half 38 of waveguide feed 10A has ribs 34C and 34D. As shown in FIG. 3A, first half 36 and a second half 38 are assembled together so that rib 34A aligns precisely with rib 34C and rib 34B aligns precisely with rib 34D. First half 36 and the second half 38 are held together with screws or bolts (not shown). The assembly of first half 36 and a second half 38 together also assists in holding a coaxial cable in place within waveguide feed 10A with proper selection of the dimensions of the components.

Referring to FIG. 4 and FIG. 4A, coaxial cable 28 may also be further secured in place within a base portion 12A of a waveguide feed if a grove 26B is formed with internal teeth, steps, or corrugations 40 for gripping the inner conductor 32 of coaxial cable 28.

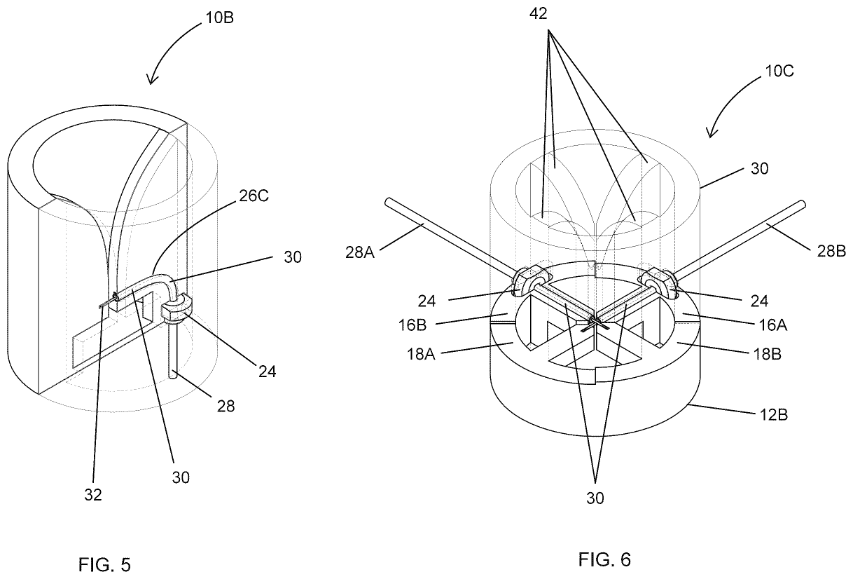

FIG. 5 illustrates an embodiment wherein a curved groove 26C is used to receive outer conductive shield 30 of coaxial cable 28. This allows coaxial cable 28 to enter waveguide feed 10 at the bottom, which may be advantageous in some installations. In other respects, the components and function of the embodiment of FIG. 5 is very similar to that of FIG. 3 and FIG. 3A.

FIG. 6 illustrates an embodiment of a waveguide feed 10C wherein there are multiple sets of ridges 42 so that waveguide feed 10C can operate in different modes, for example with different polarizations, simultaneously. Two coaxial cables 28A and 28B are received in a direction perpendicular to each other, within a base portion 12B, so that each coaxial cable supports a different polarization. Ferrules 24 secure coaxial cables 28A and 28B in place.

It is important that there be no electrical contact between inner conductor 32A of coaxial cable 28A and inner conductor 32B of coaxial cable 28B, so that there is electrical isolation between the polarizations. The isolation is effected by the upper surfaces a member 16A and a member 18A being in a first plane and the upper surfaces of a member 16B and a member 18B being in a second plane so that inner conductor 32A of coaxial cable 28A and inner conductor 32B of coaxial cable 28B do not come in contact with each other. In FIG. 6, to provide this electrical isolation, the plane of the upper surfaces of members 16A and 18A is below the plane of the upper surfaces of members 16B and 18B. It will be understood that the lower surface of waveguide portion 14B of waveguide feed 10C will be formed so as to correspond in shape to the upper surfaces of members 16A, 18A, 16B and 18B. Base portion 12B and waveguide portion 14B are assembled, using screws or bolts (not shown) so that ridges 42 properly align with the upper surfaces of members 16A, 18A, 16B and 18B.

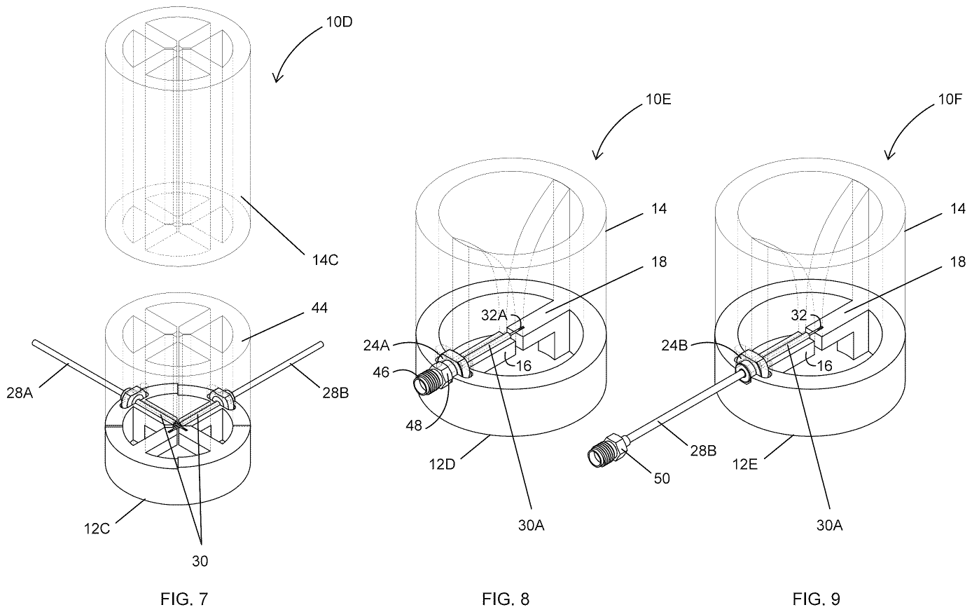

FIG. 7 is similar to FIG. 6, but the waveguide feed 10D includes a gasket or cover ring 44 placed between the base portion 12B and a continuation of the waveguide 14C.

In the embodiment of FIG. 8, waveguide feed 10E has a ferrule 24A that has extending therefrom a pigtail 30A formed of an insulator and a center conductor 32A.

Ferrule 24A is configured with a threaded end 46 and a nut shaped portion 48 which is shaped for receiving a wrench-like tool (not shown) to prevent ferrule 24A from rotating. End 46 can receive a coaxial connector at the end of a coaxial cable (not shown in FIG. 8) to allow the coupling of RF energy to and from waveguide feed 10E.

In FIG. 9, a waveguide feed 10F is connected to a coaxial cable 28B. Coaxial cable 28B is prepared with its outer insulating sheath removed to expose outer conductive shield 30A, and a portion of outer conductive shield 30A and its central insulator are removed to expose inner conductor 32. Coaxial cable 28B extends through a ferrule 24B, which is turned by a wrench engaging portion 48 of ferrule 24B to tighten upon and hold cable 28B in place. The distal end of coaxial cable 28B may be terminated with a coaxial connector 50 to couple to another coaxial cable, or to a transmitter or receiver utilizing waveguide feed 10F for operation.

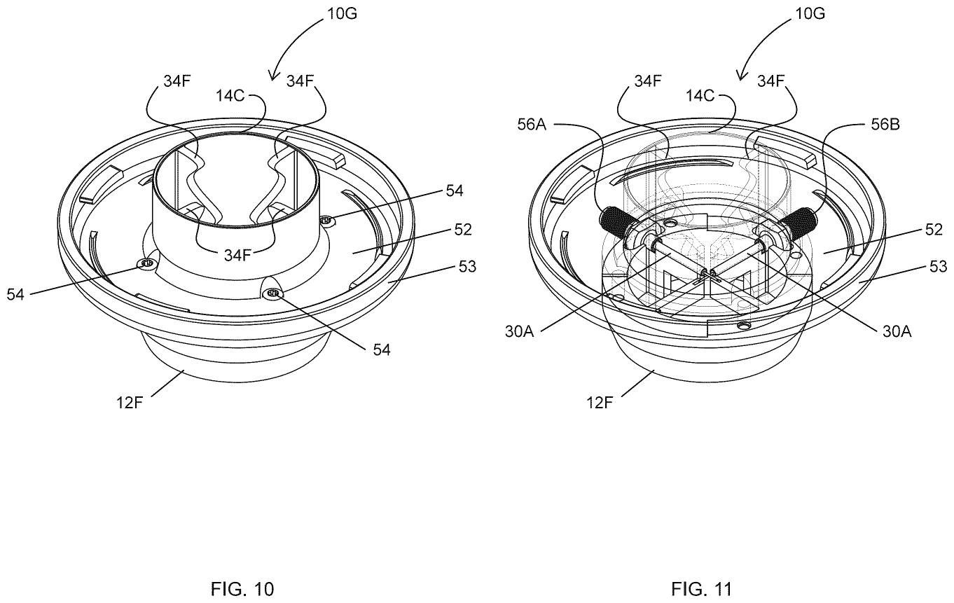

FIG. 10 and FIG. 11 illustrate a practical version of a waveguide feed 10G having a base portion 12F and a waveguide portion 14C. The waveguide portion 14C has a series of ribs 34F and a flange 52 with an upwardly extending rim 53. The waveguide portion 14C is affixed to base portion 12F by a series of screws 54. The flange 52 has four members extending inwardly from rim 53 that serve the function of a quick locking mechanism to mount the waveguide feed 10G to an antenna radiator or a waveguide extension. The quick release locking mechanism is described in detail in commonly assigned U.S. Pat. No. 11,862,833, which is incorporated herein in its entirety for all purposes.

Referring to FIG. 11, the internal configuration of the waveguide feed 10G of FIG. 10 is similar to that of the embodiment of FIG. 6. However, pigtails 30A extend to connectors 56A and 56B in a manner similar to that of FIG. 8.

FIG. 11 shows how the waveguide feed integrates into the quick release locking mechanism mentioned above. This approach separates the mounting points from the waveguide itself; therefore various waveguide diameters can be used while using the same locking mechanism. This approach eliminates user error, increases user experience and saves time for connecting or disconnecting the waveguide feed to an antenna radiator or a waveguide extension. It also allows the manufacturer to share components across multiple frequency bands of operation to reduce product cost. In FIG. 11 the waveguide portion 10D can be replaced by a different one to achieve desired properties of the antenna without the need to take the feeding structure apart (and to thus expose sensitive coaxial cables).

Thus, the structures disclosed herein have the advantages of substantially simplified manufacturing of waveguide feeds with multiple ridges, and the complete elimination of the costly process of precise drilling of small diameter holes for coaxial transmission lines. Further, these structures provide the capability of routing coaxial transmission lines even in deep-ridged structures with multiple ridges, such as dual ridged or quad ridged waveguides. A simple and secure solution for crossing multiple coaxial transmission lines in multi-polarization configurations is also provided.

Further advantages of the structures disclosed herein include enhanced mechanical stability and reliability of the waveguide structure. Waveguides are structurally split across the ridges (ridge splitting) at the coaxial transmission transition point. Re-connection of split parts can be done by usual methods such as screws and threads without interfering with the active inner area of the waveguide.

The structures described herein lend themselves to modular manufacturing techniques due to the use of components which may be standardized in shape and dimensions and shared with different designs or design variations and thus reduce manufacturing costs. For those embodiments using connectors, there is direct compatibility with various connector types, with connector attachment facilitated through unified internal structural mounting within the ridge.

In the structures disclosed herein, additional mechanical fixation elements, such as teeth, steps, or corrugations can be provided in the ridge, which, after rejoining its divided parts, firmly secure the center conductor at the desired position, while fixing the coaxial cable inside the ridge on the opposite side. This ridge connection method ensures precise and stable positioning of the center conductor, eliminating the need for additional centering and alignment.

The structures disclosed herein provide freedom in routing of the coaxial transmission line in terms of their location and trajectory, removing the necessity of the connector termination at opposing ridges. This configuration allows for internal routing of the coaxial signal within the split ridge, using bends in the coaxial cable such as 90° or more, thus providing the freedom to choose where to terminate the coaxial connector. Such freedom is useful when connectors are required to be placed according to mechanical design requirements.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

1. A waveguide feed fed by a coaxial transmission line, comprising:
at least one ridge within the feed, wherein the coaxial transmission line comprises semi-rigid or semi-flexible coaxial cable, the cable being routed inside the ridge, and electrically coupled to the ridge without using a coaxial connector.

2. The waveguide feed according to claim 1, where the ridge, at a transition between the coaxial transmission line and the ridge, is longitudinally or transversely split.

3. The waveguide feed according to claim 2, where the coaxial signal transmission line passes through multiple ridges and allows crossing multiple coaxial transmission lines within the waveguide structure, enabling multi-polarization configurations for optimized electromagnetic signal propagation.

4. The waveguide feed according to claim 1, where the coaxial signal transmission line passes through multiple ridges and allows crossing multiple coaxial transmission lines within the waveguide structure, enabling multi-polarization configurations for optimized electromagnetic signal propagation.

5. The waveguide feed according to claims 1, where the number of waveguide ridges is at least two.

6. The waveguide feed according to claim 5, where the number of waveguide ridges is four.

7. The waveguide feed of claim 1, having a configuration that enables internal routing of the coaxial signal within the ridge in a manner that alters transmission direction, whereby design flexibility is increased and integration into systems is facilitated.

8. The waveguide feed of claim 1, having a guiding groove optimized for precise placement of the coaxial transmission line, considering its diameter and routing requirements, to allow stable fixation of the coaxial transmission line and to minimize mechanical tolerances within the internal structure.

7. The waveguide feed according to claim 1, where the waveguide has a circular cross section.

8. The waveguide feed according to claim 1, where the waveguide has a rectangular cross section.

9. The waveguide feed according to claim 1, integrated as part of a coax-to-waveguide transition within an antenna.

10. The waveguide feed according to claim 1, designed to be a feed that is removable from a waveguide.

11. The waveguide feed according to claim 1, designed as a removable feed having a quick release locking mechanism.

12. The waveguide feed according to claim 1, where the coaxial transmission line is routed within the ridge in an arbitrary direction.

13. The waveguide feed according to claim 12, where the coaxial transmission line is routed within the ridge in a direction independent of a direction of a termination orientation of opposing ridges.

14. The waveguide feed according to claim 1, further comprising a second coaxial signal transmission line in a plane parallel to and spaced from a plane of a first coaxial transmission lines within the waveguide structure, so that a center conductor of the second coaxial signal transmission line and a center conductor of the first coaxial signal transmission line do not come into contact.

15. A method of assembling a waveguide feed fed by a coaxial transmission line of claim 1, and the coaxial transmission line, comprising:
removing an outer insulator layer from an end portion of the coaxial transmission line to expose an outer conductor of the coaxial transmission line;
removing the outer conductor and inner insulator layer from a center conductor of a portion of the end of the coaxial transmission line;
placing the coaxial transmission line in a groove in at least one rib of the waveguide feed; and
securing the end of the coaxial transmission line in the waveguide feed so that the outer conductor of the coaxial transmission line is in contact with a first rib of the waveguide feed and the center conductor is in contact with a second rib of the waveguide feed.

16. The method of claim 15, wherein the coaxial transmission line closely fits the groove in the rib in the waveguide feed, and the waveguide feed is split into two portions, further comprising assembling the two portions together to secure the coaxial transmission line within the waveguide feed.

17. The method of claim 15, further comprising:
fitting a ferule securely around the coaxial transmission line, and
receiving the ferule in an opening in the waveguide feed to secure the coaxial transmission line in the waveguide feed.
